(19) United States
(12) Patent Application Publication
(10) Pub. No.: US 2012/0153165 A1
(43) Pub. Date: Jun. 21, 2012

(54) POSITRON EMISSION DETECTION AND IMAGING

(75) Inventor: Robert John Ott, Devon (GB)

(73) Assignee: PETRRA LTD., Oxfordshire (GB)

(21) Appl. No.: 12/991,413

(22) PCT Filed: May 7, 2009
(86) PCT No.: PCT/GB09/01159

§ 371 Date: Nov. 5, 2010

(30) Foreign Application Priority Data
May 7, 2008 (GB) 0808310.7

(51) Int. Cl. G01T 1/164; G06K 9/00

(52) U.S. Cl. 250/362; 250/363.03; 382/131

(57) ABSTRACT

A positron emission scanner is disclosed having a timing compensation element which uses position information originating from a spatial locator element to compensate for travel time of timing signals. A method of constructing a PET image is also discussed in which a timing error function is convolved with an envelope function evaluated along a line of response to derive an emission event weight for use in image construction.

### FIELD OF THE INVENTION

The present invention relates to the imaging of a subject, by the detection of positron emission gamma rays and the subsequent analysis of data relating to the detection, for example by providing more accurate timing information and by weighting the use of data in an image construction algorithm.

Particular described embodiments use a pair of positron emission detectors having a scintillation layer formed of a material such as barium fluoride, an adjacent low pressure gas space, and an electrode grid sensor to detect the position of an electron burst travelling through the gas space.

### INTRODUCTION

Positron emission tomography (PET) is a well know technique in which a human, animal or other subject is given a dose of a tracer labelled with a positron-emitting radioisotope. A positron emitted from the radioisotope nucleus within the subject interacts with an atomic electron within a short distance of travel. The electron-positron pair annihilate to form two 511 keV gamma rays which travel away from the point of decay almost co-linearly. Gamma ray detectors disposed about the subject are used to detect these pairs of gamma rays in time coincidence, and the source of decay is assumed to be directly between the detected positions of the coincident gamma rays, along what is conventionally known as the line of response (LOR). An image of the biodistribution of the tracer within the subject is constructed using tomographic techniques from many such coincidences. Typical tomographic techniques used include filtered back-projection, and maximum likelihood expectation techniques.

A pair of gamma rays produced by an electron-positron pair annihilation may each travel to a separate gamma ray detector without any intervening scattering. In this case, for detector separations of the order of a metre, the difference in time between each gamma ray arriving at a detector will be less than about 3 ns. Generally, in order to associate pairs of detection events which are reasonably likely to originate from the same positron, only pairs of events which are closer together in time than a certain threshold, for example 12 ns, are considered coincidence events.

In Time-of-Flight (TOF) PET techniques the actual or relative arrival times at each detector are recorded, and the small time difference is used to estimate the difference between the distances travelled by each gamma ray along the LOR. This estimate of distance is then used in the image reconstruction stage, for example using confidence-weighted versions of the techniques mentioned above. The inaccuracies in the estimate of distance along the LOR are usually far larger than the inaccuracies in the LOR itself.

A significant proportion of gamma rays resulting from positron-emission annihilation in PET system operation are scattered before being detected, for example by nuclei within the subject, or from some part of the detector array or support structure. However, a scattered gamma ray may still reach a detector at a similar time to the other gamma ray of the pair, and within any coincidence time threshold for the system, to be interpreted wrongly as a line of response thereby increasing noise in the final image. Since a scattered gamma ray is likely to have an energy of rather less than the original 511 MeV, detected events having an energy below a threshold such as 400 MeV are typically discarded to mitigate this effect.

The invention seeks to provide improved timing data in respect of gamma rays detected in a positron emission system, and to provide improved image reconstruction from coincidence event data.

### SUMMARY OF THE INVENTION

The invention relates to gamma ray detection for positron emission imaging, especially tomographic imaging of a subject, such as a human or animal subject for medical purposes.

In particular, a first aspect of the invention relates to a gamma ray detector with a scintillation layer, behind which is a low pressure gas space. An electron burst is generated in response to a gamma ray striking the scintillation layer, for example by conversion of ultraviolet photons from the scintillation layer causing photo-ionisation in the low pressure gas. The electron burst moves through the low pressure gas space to a locator element, such as a multi-wire proportional counter, which provides position information indicative of where on the scintillation layer the gamma ray struck. This position information may be used in imaging the subject. A timing signal for the incident gamma ray is received from a timing electrode plane within the low pressure gas.

According to the invention, the timing signal is adjusted to compensate for different possible travel times of the signal within the timing electrode plane by using position information originating from the locator element. This compensation may be carried out by a timing compensation element.

This compensation improves the accuracy of the timing information sufficiently for time-of-flight of the gamma rays to be taken into account in reconstructing an image of the subject.

Typically, the scintillation layer, the timing electrode plane and the locator element will be substantially parallel, defining a detector plane, with the position information indicating a position or coordinates within that detector plane.

The timing signal represents drift of the electron burst through the timing electrode plane. When using two opposing gamma ray detectors, a coincident timing signal from both detectors, for example coincident within a small window of perhaps 12 nanoseconds, may be taken as indicative of two collinear gamma rays originating from a single positron-electron annihilation event. This determination may be made by a coincidence detector. A trigger signal may then be sent to a gate electrode plane in each detector to permit the electron bursts to pass to the respective locator elements. This mechanism reduces the number of electron bursts reaching the locator element by perhaps two orders of magnitude. The locator element may be a multi-wire proportional counter using delay lines to establish signals carrying the position information.

The timing electrode plane may be formed of a plurality of coplanar and parallel wires, and the position information is then used to estimate position at which the electron burst drifted through or past one or more of the wires, for example as a distance along the wires from a terminus end at which the signal is received. The timing information is then compensated for the travel time of the timing signal along the wires.

Other aspects of the timing signal may also be compensated, for example using predetermined adjustments according to different travel times from the terminus of different parts of the timing electrode plane.

Separate compensated timing information may be generated for the or each detector, or difference compensated timing information, representing the time between two coincident gamma rays striking scintillation layers of two detectors, may be generated and output.

The invention provides one or more gamma ray detectors with appropriate control and data processing elements implementing the above, a system comprising at least two such gamma ray detectors, and a system further comprising data processing elements adapted to carry out construction of an image of the subject using the position and compensated timing information generated for the gamma ray coincidence events. The invention also provides corresponding methods, computer program elements, and computer readable media carrying such program elements.

A second aspect of the invention relates to construction of images of a subject using position and timing information generated for gamma ray coincidence events. This information may be generated by a gamma ray detection system as set out above and described in detail herein, or using other gamma ray detection systems such as a more conventional PET scanner. The compensated timing data may also advantageously be used within this aspect.

According to the second aspect a positron emission density image of a subject within a three dimensional subject space is constructed from detections of coincident positron emission gamma rays. Data defining a plurality of lines of response through said subject space is provided, the lines of response linking locations of said gamma ray detections. This data could be provided, for example, as coordinates of coincident gamma ray detections in the planes of each of two detectors, in association with the position and orientation of the detectors in the subject space.

For each line of response or coincidence event, an estimate of the positron emission location is provided, for example from absolute or difference timing information of the gamma ray detections of a coincidence event. Such an estimate is likely to be very approximate, with a 1 nanosecond uncertainty corresponding to about 200 to 300 mm in the subject space.

An envelope function is then provided within the subject space. The envelope function is intended to approximate the expected positron emission density image to be constructed, although this approximation could be very crude, for example a simple geometric form, or much more sophisticated.

A timing error function is then provided which is representative of the uncertainty of the positron emission location derived from the timing data. The timing error function may typically feature a peak at a best estimate of the emission location from the timing information, the breadth of the peak being representative of the uncertainty in the position of the emission location arising from errors in the timing information.

An evaluation of the envelope function along the line of response is then convolved with the timing error function evaluated along the same line of response and aligned according to the estimate of emission location. The result of the convolution is an emission event weight. An image of the subject is then constructed from each line of response weighted according to the emission event weight.

The envelope function could take a variety of forms. For example, geometric forms could be used such as a cylinder or sphere aligned and sized according to the expected subject image. The function could be two valued, with a larger value within the form and a smaller or zero value outside the form, or the function could be graduated with stepped or continuous values. More sophisticated predefined shapes, for example an approximate heart or kidney shape could be used.

The envelope function may be defined based on data derived from a scan of the subject, such as an X-ray CT scan or ultrasound scan.

The envelope function may also be defined iteratively. For example, a first image construction may be carried out without using an envelope function and timing error function convolution, or using an initial approximate envelope function, with a subsequent envelope function being generated from the image of the first image construction. Further iterations may be carried out to refine the envelope function and image.

The timing error function may take a variety of forms such as a Gaussian peak or a triangular peak, with the breadth of the peak representative of the uncertainty in the position of the estimated emission location due to errors and uncertainties in the timing information.

The invention also provides a data processing apparatus suitable for carrying out the above method, in particular a suitably programmed computer, and more extensively, a system adapted to establish the required coincidence event data such as a positron emission detection system in conjunction with such a data processing apparatus. The invention may also provide such a system incorporating a CT scan, ultrasound scan or other system for deriving an envelope function. Computer program code, and computer readable media carrying such code, the code being arranged to carry out the described methods, are also provided.

The coincidence event data may be stored in a database for use in the image reconstruction.

### BRIEF DESCRIPTION OF THE DRAWINGS

Embodiments of the invention will now be described, by way of example only, with reference to the accompanying drawings, of which:

FIG. 1 illustrates positron emission tomography imaging using two gamma ray detectors, which could be mounted on a rotatable gantry;

FIG. 2 is a sectional schematic of the scintillation layer, and electrode structure within a low pressure gas space, of a gamma ray detector of FIG. 1;

FIG. 3 illustrates a timing electrode plane of the detector of FIG. 2;

FIG. 4 illustrates a diametric configuration of two detectors, and in particular the diametric configuration of the timing electrode planes;

FIG. 5 schematically shows control and data processing related to two of the subject gamma ray detectors;

FIG. 6 illustrates a convolution between a timing error function and a subject space envelope function along a line of response to derive a weight for biasing use of coincidence event in image construction;

FIG. 7 shows a patient between two detectors, for the purpose of discussing time of flight corrections; and

FIG. 8 illustrates the ratio of true events to scatter events as a function of timing difference.

### DETAILED DESCRIPTION OF EMBODIMENTS

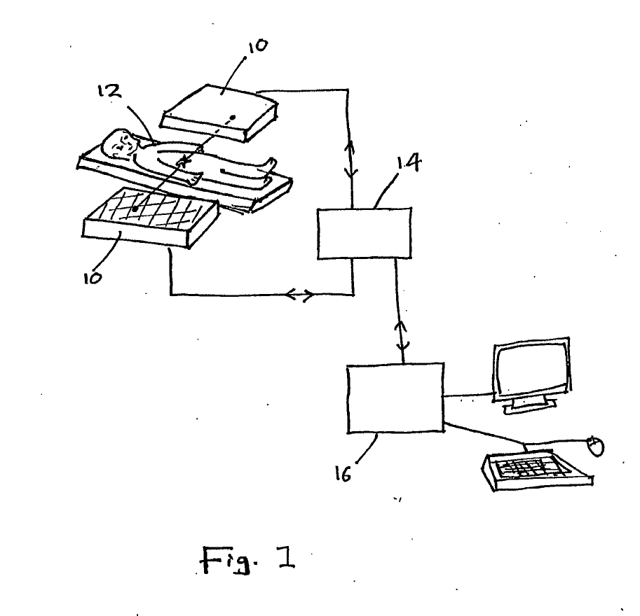

Referring now to FIG. 1 there is shown a positron emission scanner comprising two gamma ray detectors 10 disposed at either side of a human, animal or other subject 12. The detectors 10 are connected to a control and signal handling function 14 which provides operational control of the two detectors, and prepares and outputs data relating to coincident gamma rays recorded by the two detectors. The control and signal handling function 14 may be provided in various ways, for example as a single or as distributed units, with aspects implemented in software, hardware or a combination of the two, and so forth. Data relating to coincidence events is passed to a data processor 16 which uses the coincidence data to construct an image of the distribution of the radioisotope labelled tracer within the subject 12 using tomographic techniques.

### Gamma Ray Detectors

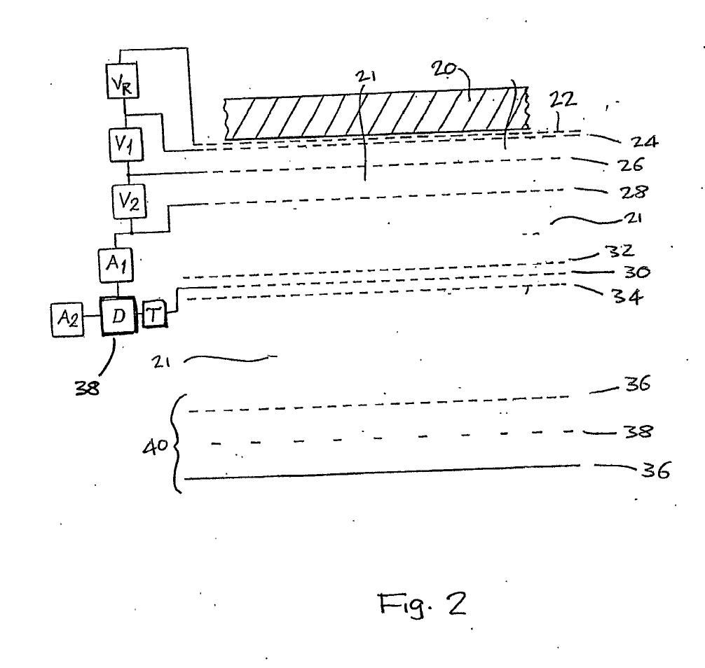

FIG. 2 illustrates, schematically, a section through one of the gamma ray detectors 10 of FIG. 1, from a scintillation layer 20 formed of tiles of barium fluoride (BaF₂) crystals, to a locator element provided by a multi-wire proportional counter (MWPC) 40, which is adapted to detect a position, in particular coordinates in the major plane of the detector, of an electron burst generated in the detector by an incident gamma ray. Between the scintillation layer 20 and locator MWPC 40 is a low pressure gas space 21 which contains heated TMAE gas (tetrakis (dimethlyamino) ethylene) at a pressure of about 4 mb at 60° C., which has a photoionization potential of 5.36 eV, making it suitable for amplifying the approximately 190 nm photons emitted by the BaF₂. Details of the construction and operation of a detector as shown in FIG. 2 are set out in WO93/08484, but in brief the detector is arranged as follows.

The scintillation layer may be constructed using one or more arrays of adjacently stacked of BaF₂ crystal rods each of which is aligned to extend in the plane of the scintillation layer, as discussed in copending application GB0709381.8, which is hereby incorporated by reference. Constructing the scintillation layer using rods aligned within the layer permits a thicker layer to be used while mitigating the loss of spatial resolution of the detector this would otherwise cause. In particular, the divisions between the rods reduces the lateral distance, in the width direction of the rods, over which uv photons generated within the layer can travel before entering the low pressure gas space. The provision of slots in each rod similarly limits the lateral distance in the length direction of the rods, over which uv photons can travel. The lateral travel of uv photons in directions coplanar with the scintillation layer is thereby reduced. However, the rods are still reasonably practical to handle and assemble into a frame or other structure to complete the scintillation layer. This is particularly important in larger area detectors, where even using this technique, hundreds of rods may be required.

Conductive wire 22 of 25 μm diameter is wound around each BaF₂ crystal with a 250 μm pitch. A first wire plane 24 consisting of 50 μm diameter wire at a pitch of 500 μm is spaced 0.5 mm from the scintillation layer 20. A second plane 26 consisting of 100 μm wire at 1 mm pitch is spaced 3.0 mm from the first plane. A third plane 28, which acts as a timing electrode plane, also consists of 100 μm diameter wire at 1 mm pitch spaced 9.0 mm from the second plane. A gate electrode plane 30 comprising 100 μm wires at 1 mm pitch is positioned 20 mm from the timing electrode plane and has first and second metallic copper mesh screens 32, 34 positioned one on either side. The MWPC is spaced 13.2 mm beyond the gate and is consists of two cathode planes 36 formed of 50 μm wire at 2.0 mm pitch and an anode/cathode plane 38 of 20 μm anode wires perpendicular to 100 μm cathode wires at 4.0 mm pitch. Delay lines are used to read the magnitude and x/y coordinates of an electron burst from the anode/cathode plane.

Incident gamma radiation causes the BaF₂ crystal of layer 20 to scintillate, generating ultra violet photons. Some of the UV photons convert in the low pressure gas space adjacent to the crystal, and the resulting electrons are avalanche amplified in the V₁=300 V/mm electric field applied between the first and second planes and the lower V₂=150 V/mm electric field applied between the second and third planes. A small reverse bias V_{R}<100 Volts is applied to the mesh 22 to prevent build up of positive ions at the scintillation layer. The use of two separate acceleration regions, between the first and second, and second and third planes, permits sufficient electron cascade amplification without instabilities.

The gate electrode plane 30 is normally biased by ±30 V on alternate wires, which causes the plane to act as a barrier to passing electron bursts. If a passing electron burst is detected at the third plane 28, this first signal being represented in FIG. 2 by current A₁, and an electron burst is detected at the same time at the third plane of the other, complementary gamma ray detector 10, this second signal being represented in FIG. 2 by current A₂, then coincidence detector 38 brings the voltages of the gate electrode wires together to allow the electron burst to pass on to the MWPC, as represented by trigger signal T. In this way, gamma rays having no coincidence at the other detector do not lead to a signal at the MWPC, so that the duty cycle of the MWPC is dramatically reduced, by a factor of up to 100. The coincidence detector 38 forms part of the common control and data processing circuitry shown as 14 in FIG. 1.

The signal applied to the gate is of very high frequency, and the copper mesh screens 32, 34 positioned either side of the gate, which are held at a voltage consistent with drift of electrons past the gate and on towards the MWPC, act to shield this high frequency signal from the rest of the detector.

Although a gamma ray detector using TMAE gas as the photoionization medium has been described, other photoionization arrangements could be used, for example incorporating a more conventional low pressure gas such as Helium or Argon.

### Timing Electrode (Third) Plane

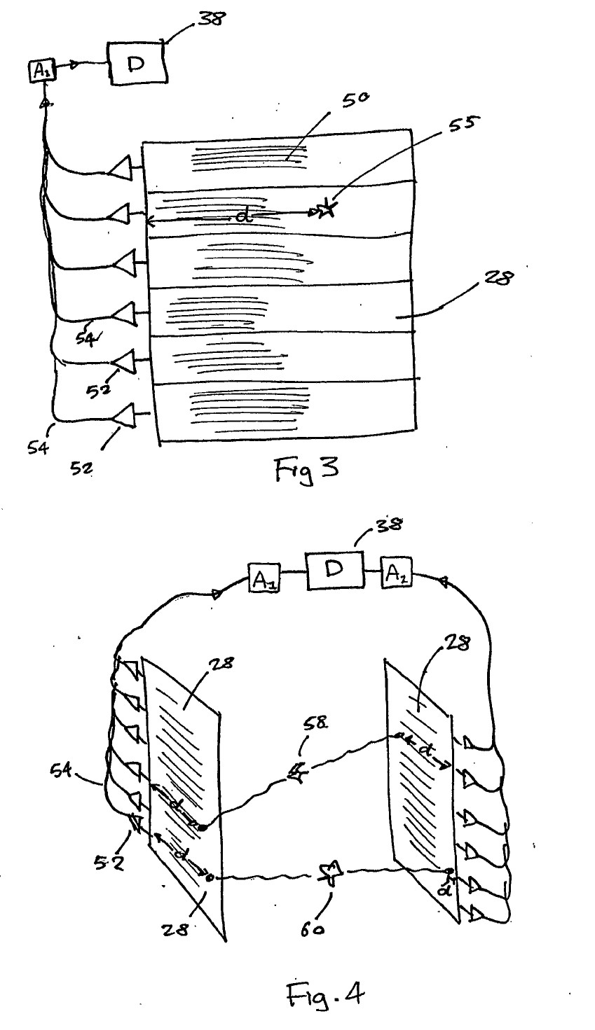

FIG. 3 shows in schematic plan view a third plane 28 of one of the gamma ray detectors 10. The wires 50 of the third plane 28 are grouped into blocks of adjacent wires for connection to preamplifiers 52. In this embodiment there are six preamplifiers, and six corresponding blocks of plane wires 50. Each preamplifier 52 is connected by a separate cable 54 to the coincidence detector 38. The grouping of the wires and the arrangement and lengths of other connections and cables 54 is preferably devised such that a signal A₁ originating in the third plane 28 in response to a passing electron burst 55 takes about the same length of time to reach the coincidence detector 38 regardless of which particular wire or wires of the third plane the electron burst 55 passes closest to. For example, it may be desirable to ensure that all of the cables 54 are of the same length.

The time taken for a signal A₁ to arrive at the coincidence detector also depends on the distance from a preamplifier, along a wire of the third plane, of the passing electron burst 55, illustrated in the figure as distance d. The velocity of the signal A₁ along a wire of the plane may typically be about 200 mm per nanosecond, corresponding to a time variation of several nanoseconds dependent upon the position of the electron burst.

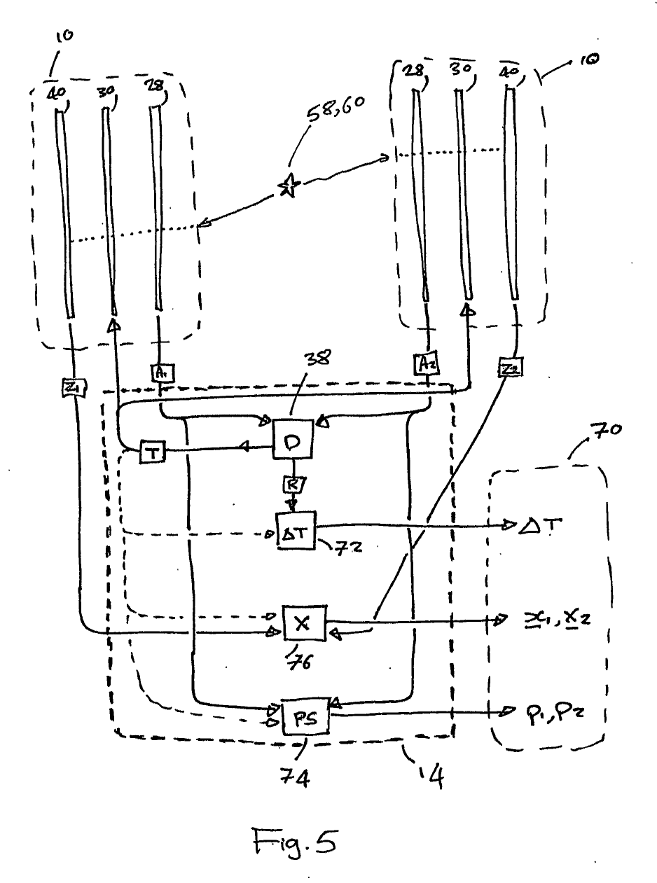

To reduce the effect of signal travel time along the third plane wires upon the detection of coincidences, the preamplifiers 52 and connections to the third plane of one of the gamma ray detectors 10 are disposed at the opposite end to those of the other, as illustrated in perspective in FIG. 4, in a diametric geometry, noting that the major planes of the two detectors are approximately parallel. Consider a positron decay event 58 at a central point between the detectors 10. The emitted gamma rays are approximately collinear. As a consequence, if one of the gamma rays strikes a detector to give rise to an electron burst far from the preamplifiers, it also strikes the other detector to give rise to an electron burst far from the preamplifiers. Equally, if one of the gamma rays strikes one detector close to the preamplifiers, it also strikes the other detector close to the preamplifiers. In both situations, distance d and so also the delays in the signals A₁, A₂ in reaching the coincidence detector is about the same for both detectors, so that the time difference discerned by the coincidence detector is not dependent on signal travel time within the third plane wires.

The described diametric geometry is of decreasing benefit in terms of balancing the delays as a gamma ray event occurs further from a plane joining the centrelines of the third plane wires of both detectors. Consider off-centre positron decay event 60 which gives rise to a signal A₁ which originates close to the preamplifiers in the third plane wires of one detector, and signal A₂ which originates far from the preamplifiers 54 of the other detector. If the third plane wires are each about 600 mm in length then this gives rise to a difference of up to about 3 nanoseconds between the times of arrival of the signals A₁, A₂ at the coincidence detector. This time difference can be corrected by using knowledge of the spatial coordinates, for example the distance d, in each detector plane of the electron burst, for example from the MWPC signals, as described in more detail below.

### Detector Control and Signal Handling

FIG. 5 illustrates how the control and signal handling function 14 interacts with the detectors 10 to output event data 70 relating to a coincidence event. In FIG. 5 only some elements of each detector 10 are shown, in particular the timing electrode (third) plane 28, gate electrode plane 30, and locator element (MWPC) 40. Other elements are omitted from the figure to aid clarity. The control and signal handling function 14 includes the coincidence detector 38 already discussed, but further includes a time compensation function 72, a pulse size function 74 and a spatial coordinate function 76. The role of these functions or elements are to provide, as an output to the data processor for each coincidence event, the event data 70 including a two dimensional coordinate of the position of the detected gamma ray in the major plane of each detector x₁, x₂; a measure representative of the pulse size of each gamma ray detection p₁, p₂; and a measure of the time delay between the two detection events Δt.

When an electron burst passes both third planes 28 at about the same time, this coincidence is detected by the coincidence detector 38, for example by judging the arrival time of signals A₁ and A₂ to be within about 12 nanoseconds of each other at the coincidence detector. The detector 38 then sends a trigger signal T to the gates 30 to permit the electron bursts to pass on to the locator elements 40. Each locator element then generates a signal Z₁, Z₂ which represents the coordinates in the plane of each detector of the respective electron bursts. The signals Z₁, Z₂ are received by the spatial coordinate function which generates the coordinates x₁, x₂.

From the time of arrival at the coincidence detector 38 of the signals A₁ and A₂ from the respective third planes, the coincidence detector 38 is able to generate a raw time difference R. This is passed to the time compensation function 72. As described above in connection with FIG. 4, this raw time difference includes an element attributable to the travel times of signals along the wires of the third plane, dependent on the geometry of the coincidence event. The time compensation function 72 also receives position information such as spatial coordinate signals, for example from the coordinates x₁, x₂ from the spatial coordinate function, and uses this information to correct the raw time difference to output a compensated timing information which is a measure of the time delay between the two detection events, Δt.

If the coordinates x₁, x₂ indicate distances d₁, d₂ of the electron bursts detected in the third plane from the ends of the wires in each plane at which the corresponding signal is collected and amplified, and the speed of travel of the signal along the third plane wires is v, then Δt may be determined by adjusting the raw time difference by an amount (d₁−d₂)/v to compensate for travel along the wires of the third plane, with the sign of the adjustment being determined as appropriate.

The pulse size data p₁, p₂ may be determined from the strength of the signals A₁, A₂, either by the coincidence detector 38, or as illustrated in FIG. 5 by a separate pulse size function 74. Generally, to ensure that the correct signals are used in generating the time difference, pulse size, and coordinate data, the trigger signal T from the coincidence discriminator, or another appropriate trigger signal, may be passed to the time difference, spatial coordinate and pulse size functions as illustrated by the broken line portion of the trigger signal T.

The control and signal handling function 14 may implement some filtering of the coincidence data in addition to the gating function described above in connection with FIG. 2. For example, a minimum pulse size for one or both pulses of a coincidence event may be enforced, and a maximum time delay (either raw or compensated) may also be implemented, with coincidence data not meeting these restrictions being discarded.

Whereas some aspects of the described control and signal handling function will be implemented using electronic circuitry, some aspects may be implemented in software, or may be incorporated instead in functions of the data processor 16 or elsewhere. For example, the compensation of the time difference for signal travel time in the third plane wires may be handled using suitable computer software based on an uncompensated version of the Δt in the coincidence event data 70, and the coordinates x₁, x₂ in the event data.

Separate compensated timing information may be output for each detector, as well as or instead of difference timing information.

Other corrections to the raw time difference signal may also be implemented in a similar manner to those described above. For example, adjustments to allow for different lengths of cables 54 from the preamplifiers 52 of different groups of third wire planes may be implemented by determining the appropriate wire group from the detected spatial coordinates, and applying an adjustment predetermined for that particular wire group.

Although in FIG. 4 the timing electrode (third) planes of the two detectors are set in a diametric configuration, to partly compensate for signal delay within the planes for centralised positron decay events 58, this is no longer so important when the described timing information compensation technique is used, because the compensation mechanism can take account of arbitrary detector and third plane geometries and orientations.

### Weighting of Data in Image Construction

An image of the subject 12, or more particularly, an image of a tracer distribution within the subject, is constructed using event data 70 or a subset thereof from a large number of coincidence events, using a tomographic technique such as filtered back-projection, and maximum likelihood expectation techniques. In these techniques, a weight can be attributed to each event, so that some events have a greater influence on the constructed image than others.

The spatial coordinates of each event are used to define a line of response LOR, somewhere upon which the two detected gamma rays are presumed to have originated at a positron emission event. Without any time difference data, nothing is known about the position of the event along the LOR. However, once some timing information is available, this can be used to influence the image construction, as long as the uncertainty in the timing information is small enough, for example, less than about 3 nanoseconds corresponding to roughly 900 mm of gamma ray travel in free space, or 600 mm in a human or animal subject. The uncertainty in the timing information can be reduced, for example, using the techniques described above for low pressure gas space gamma ray detectors.

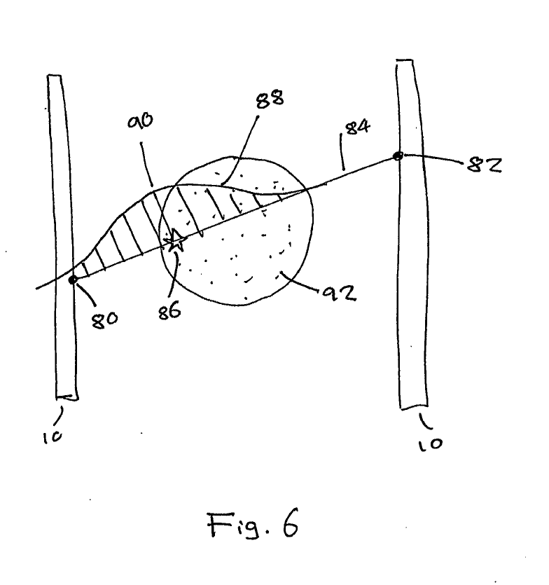

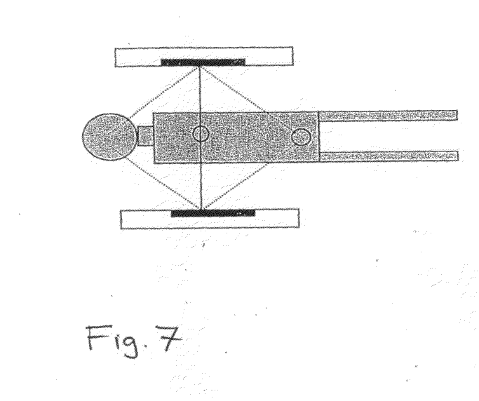

A weight for a coincidence event which is based on the timing information can be derived using an estimate of the uncertainty in the timing information, and an estimate of the expected positron emission density which forms the subject of the constructed image. FIG. 6 illustrates two opposing gamma ray detectors 10 operated, for example, as described above. A positron emission event occurs and gives rise to gamma rays detected at locations 80 and 82, which may be represented as coordinates on the surface of each detector, which are easily translatable into the more general subject space common to both detectors through knowledge of the detector positions and orientations to define a line-of-response (LOR) 84 passing through the subject space.

The position of the positron emission on the line of response is not known accurately, because uncertainties in the timing information are large. However, a best estimate of the position is shown as 86. A timing error function 88 representative of the uncertainties in the timing information can be evaluated along the LOR, and will typically have a peak 90 at the best estimate of the emission position based on the timing information. In FIG. 6 the timing error function has a Gaussian form with a half width peak roughly one third of the spacing between the detectors 10, but other forms including a triangular function, or shapes which take account of more analytical or empirical estimates of the timing error can be used.

The timing error function may also vary according to the data upon which the line of response is based, for example it may vary according to the position of the end points of the LOR, including angle of the LOR relative to the detector planes. It may depend upon the detected pulse sizes, for example having a narrower peak for larger pulse sizes which have better timing certainty.

An envelope function 92 is provided which is based on a prior estimate of the expected positron emission density to form the image to be constructed. The prior estimate may be very crude, such as a simple geometric shape such as a cylinder or sphere, with just two, many, or a continuous range of values within the space, and with sharply defined or more diffuse features and boundaries. More sophisticated envelope functions can include a form based on an X-ray scan CT image, ultrasound imagery, and prior models of organ forms such as a prior estimate of a kidney or heart shape.

The envelope function 92 may also be based on a previous construction of the positron emission density image, which itself used no envelope function, or used an initially estimated function such as a simple geometric form. The process of using an envelope function to generate an image, and using the image to generate a more refined envelope function may be iterated.

To derive a weight an evaluation of the envelope function along the LOR is convolved with the timing error function along the same LOR. For example, the two functions so evaluated may by multiplied together at regular intervals along the LOR, the products summed, and the result normalised as appropriate. The weight so derived is then used to provide a weighting for the use of the coincidence event data for that LOR in a construction of the subject image, for example using a filtered back projection technique.

### Time of Flight Weighting

The apparatus as described herein may be operated by accepting all events within a preset timing window and this allows events to be accepted even if they are obviously outside the field of view of the camera. All that is required is that a trigger is received by the third plane amplifiers of each detector within this timing window and that a positional readout is provided by each detector.

However, measurement of the spatial coordinates of the event can provide a time marker to about 25 ps for comparison with the timing difference, and this can be used to compare with the time of flight measurement for each event to accept true events and reject a large number of random coincidences or scattered photons. FIG. 6 illustrates the effect for a 20 cm detector long field of view appropriate for cardiac imaging. For an average height male patient the axial distance between the heart and the two other major sources of activity (the brain and the bladder) is about 40 cm.

In FIG. 6 the heart is centred and the brain and bladder are displaced about 40 cm along the axis. The separation of the BaF₂ scintillation layers is assumed to be 90 cm and the detectors are 60 cm long transaxially. During use on a patient injected with a tracer, about 10% of the injected activity is in the heart and the brain and about 80% in the bladder. The time of flight of true events from the heart and scattered events from the bladder and brain are as follows in table 1:

TABLE 1

| | True | Scatter |
|---|---|---|
| Direct | 3.67 ns | 4.67 ns |
| Oblique | 4.33 ns | 5.33 ns |

Hence there is only about 1 ns difference between good events and scattered events independent of whether the events are directly across the detectors or obliquely into the corners. Without comparing timing differences with event coordinates the timing resolution may be about 3.5 ns FWHM with a roughly Gaussian distribution of events (standard deviation about 1.5 ns). The timing difference (dT) between the coincidence events measured using the timing discrimination circuits and that measured from event coordinates can be used to discriminate between true events and scattered events because scattered events will tend to have a higher probability of occurring later than the true time (+dT).

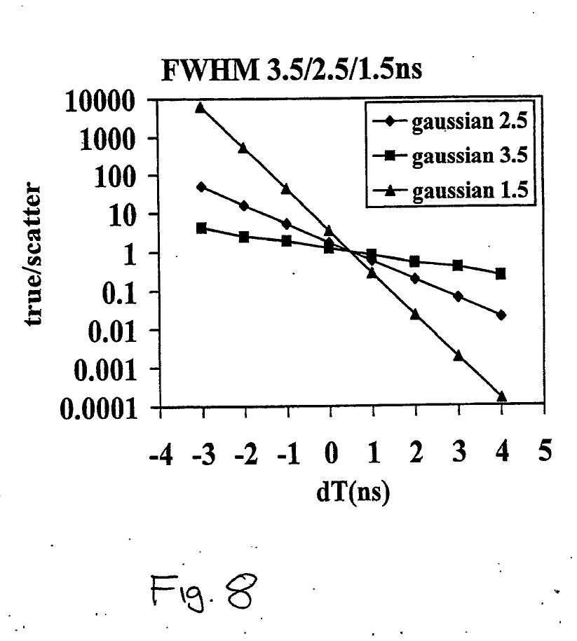

The ratio of true to scatter events (T/S) as a function of dT is shown in FIG. 7. Also shown are the ratios for timing resolutions of 2.5 ns and 1.5 ns FWHM. These calculations are approximate due to assumptions that the true shape of the timing function is Gaussian, but they show that time-weighting as described here will reduce the number of scatter events detected from even the brain and bladder. Events from further away such as the legs and scatters from the gantry, detectors, and parts of the building in which the equipment is housed such as floor and ceiling would be further reduced. Overall, the timing resolution may be improved, for example from about 2.5 ns to about 1.5 ns.

Although particular embodiments have been described, variations and modifications will be apparent to the skilled person without departing from the scope of the invention as defined in the appended claims. For example, the described data weighting technique does not require the use of the gamma ray cameras described herein in detail, and other sources of coincidence data may be used.

1. A positron emission scanner comprising:
at least two gamma ray detectors, each detector having a scintillation layer extending in a respective detector plane, a low pressure gas space behind the scintillation layer, a timing electrode plane disposed in the gas space to detect a passing electron burst resulting from incidence of a gamma ray on the scintillation layer, a locator element disposed in the low pressure gas space for detecting a position in the detector plane of the electron burst, and a gate electrode plane disposed in the gas space to control passage of the electron burst to the position detector;
a coincidence detector arranged to receive a timing signal from both of said timing electrode planes, to detect timing signal features indicative of coincident gamma rays at the two detectors, and to operate the gate electrode planes to allow the electron bursts arising from said coincident gamma rays to travel to the locator elements; and
a timing compensation element adapted to use position information originating from each locator element, which is indicative of a position in the detector plane of the electron burst, to generate compensated timing information adjusted for travel time of the timing signals within the timing electrode planes.

2. The scanner of claim 1 wherein the compensated timing information is information indicating a timing difference between the timing signals received from the timing electrode planes for coincident gamma rays, compensated for travel time of the timing signals within the timing electrode planes.

3. The scanner of claim 1 wherein each locator element is a multi-wire proportional counter arranged to output position signals indicative of the position of an electron burst through signal delay lines, such that the delay of the position signal is indicative of the position of the electron burst.

4. The scanner of claim 1 wherein the timing electrode plane comprises a plurality of parallel wires extending within the detector plane.

5. The scanner of claim 4 wherein the timing compensation element uses the position along the wires of a passing electron burst to generate the compensated timing information.

6. The scanner of claim 1 wherein the scintillation layer, the timing electrode plane, and the locator element of each detector are substantially parallel.

7. The scanner of claim 1 further comprising a data processing element adapted to construct an image of a subject between the two or more gamma ray detectors using the compensated timing information and the position information.

8. A method of operating a gamma ray detector which includes a scintillation layer in the major plane of the detector, and a low pressure gas space behind the scintillation layer containing a timing electrode plane and a locator element, comprising:
receiving a timing signal from the timing electrode plane indicative of a electron burst, generated in response to a gamma ray striking the scintillation layer, passing through the timing electrode plane;
receiving position information from the locator element indicative of the position in the major plane of the detector of the electron burst; and
generating compensated timing information from the timing signal using the position information to compensate for the time of travel of the timing signal within the timing electrode plane.

9. A method of operating two opposing gamma ray detectors each operated according to claim 8, further comprising:
determining if timing signals received from both detectors indicate coincident gamma rays received from a single annihilation event; and
if a coincidence is indicated, operating a gate electrode plane in each detector to allow the corresponding electron bursts to pass to the locator elements.

10. The method of claim 9 wherein the compensated timing information is a measure of the delay between the timing signals originating at the two detectors, compensated for time of travel of the signals within the timing electrode planes using position information derived from both detectors.

11. The method of claim 8 further comprising constructing an image of a subject within which the gamma rays are generated by positron emission, using the position and compensated timing information.

12. A method of constructing a positron emission density image of a subject within a subject space from detections of coincident positron emission gamma rays, comprising:
providing data defining a plurality of lines of response through said subject space, the lines of response linking locations of said gamma ray detections, and timing information of said gamma ray detections;
for each line of response providing an estimate of the positron emission location from said timing information;
providing an envelope function within the subject space;
convolving a timing error function with the envelope function evaluated along the line of response, the timing error function being aligned with the evaluated envelope function according to the estimate of positron emission location, to derive an emission event weight; and
constructing an image of the subject from each line of response weighted according to the emission event weight.

13. The method of claim 12 wherein the envelope function approximates the expected positron emission density image.

14. The method of claim 12 wherein the envelope function is derived from an image constructed from the same data without using a step of convolving an envelope function with a timing error function.

15. The method of claim 12 wherein the envelope function is derived from an image constructed from the same data using the method of claim 12 and an already established envelope function.

16. The method of claim 12 wherein the envelope function is derived from an X-ray CT scan of the subject.

17. The method of claim 12 wherein the envelope function is a predefined function.

18. The method of claim 12 wherein the timing error function includes a peak having a breadth representative of the uncertainty in the estimate of the emission location based on the timing data, and the convolution is carried with the peak of the timing error function aligned with the estimated emission location.

19. The method of claim 12 further comprising:
operating a gamma ray detector which includes a scintillation layer in the major plane of the detector, and a low pressure gas space behind the scintillation layer containing a timing electrode plane and a locator element, by receiving a timing signal from the timing electrode plane indicative of a electron burst passing through the timing electrode plane, the timing signal generated in response to a gamma ray striking the scintillation layer, receiving position information from the locator element indicative of the position in the major plane of the detector of the electron burst, and generating said timing information from the timing signal using the position information to compensate for the time of travel of the timing signal within the timing electrode plane.

20. (canceled)

21. (canceled)

22. (canceled)

23. A computer readable medium comprising computer program code arranged to construct a positron emission density image of a subject within a subject space from detections of coincident positron emission gamma rays, the computer program code comprising code for:
providing data defining a plurality of lines of response through said subject space, the lines of response linking locations of said gamma ray detections, and timing information of said gamma ray detections;
for each line of response providing an estimate of the positron emission location from said timing information;
providing an envelope function within the subject space,
convolving a timing error function with the envelope function evaluated along the line of response, the timing error function being aligned with the evaluated envelope function according to the estimate of positron emission location, to derive an emission event weight; and
constructing an image of the subject from each line of response weighted according to the emission event weight.

24. Apparatus for constructing a positron emission density image of a subject within a subject space from detections of coincident positron emission gamma rays, using an envelope function within the subject space, the apparatus comprising:
an input for receiving data defining a plurality of lines of response through said subject space, the lines of response linking locations of said gamma ray detections, and timing information of said gamma ray detections;
an estimator for providing an estimate of the positron emission location from said timing information for each line of response;
a convolver for convolving a timing error function with the envelope function evaluated along the line of response, the timing error function being aligned with the evaluated envelope function according to the estimate of positron emission location, to derive an emission event weight; and
a constructor for constructing an image of the subject from each line of response weighted according to the emission event weight.
